(19) United States
(12) Patent Application Publication
(10) Pub. No.: US 2004/0086096 A1
(43) Pub. Date: May 6, 2004

(54) Public switched telephone network autosense

(76) Inventor: Carl C. Hansen, Aloha, OR (US)

Correspondence Address: Glen B. Choi, BLAKELY, SOKOLOFF, TAYLOR & ZAFMAN LLP, 12400 Wilshire Boulevard, Seventh Floor, Los Angeles, CA, 90025, US

(21) Appl. No.: 10/286,229

(22) Filed: Oct. 31, 2002

(51) Int. Cl. H04M 11/00

(52) U.S. Cl. 379/93.07

(57) ABSTRACT

A telephony service device has a digital interface, an analog telephone line interface, and circuitry operable to provide telephone service over the analog telephone line interface via a network connection to the digital interface. A telephone network signal detector comprising a part of the device is operable to detect a telephone network signal on one or more telephone lines connected to the analog telephone interface, and a switch is operable to automatically connect the telephony service device to a line on the analog telephone interface on which the telephone network signal detector did not detect a telephone network signal.

### FIELD OF THE INVENTION

The invention relates generally to telephone systems, and more specifically to autosensing a public switched telephone network-type system.

### BACKGROUND OF THE INVENTION

The traditional international telephone system, commonly known as the Public Switched Telephone Network (PSTN), comprises analog voice signals carried over switched copper wires to provide telephony service to subscribers. The telephone service provided via the PSTN is commonly known as POTS, or Plain Old Telephone Service. As the system matured, various technologies such as radio and fiber optic communication were used to improve the capacity or reliability of certain stages of the system, such as to carry long distance traffic between areas of the country and world. But, the local exchange carriers still provide a traditional PSTN copper connection to consumers, so that older traditional telephones are still compatible with the PSTN system.

New telecommunications equipment such as fax machines and modems are specifically designed to be compatible with the PSTN telephone network, and still connect to the telephone system via the same RJ-11 type connectors that standard telephones have traditionally used. Because even residential homes often desire multiple lines of PSTN service, the standard RJ-11 connectors and related house wiring are typically installed configured with two or more pair of wires to support a corresponding two or more lines of POTS service.

More recently, PSTN lines have been used in some systems to provide Digital Subscriber Line (DSL) service, which comprises a high-bandwidth digital connection between a switching device and the subscriber's premises equipment. DSL is used to provide a variety of services, including Internet service and telephony service. Internet service is provided via a DSL modem that interfaces the DSL signal coming in through the PSTN system to a computer or computer network, and telephony service is provided via a device such as an IAD, or integrated access device.

In voice telephony over DSL, the IAD or other device must interface with a telephone system within the subscriber's location to provide connection to traditional telephone equipment via the traditional RJ11 telephone jacks and copper wiring. Therefore, the installer of such a system must determine what pair of wires the DSL signal is carried on, connect the DSL connection of the IAD or other device to the DSL signal pair, and connect the subscriber's telephony equipment and IAD device telephony connection to another pair. This must be done to prevent the locally generated telephony signals from interfering with the signal provided by the local telephone service provider, and generally requires a telephone service technician to visit the premises to properly configure the system. Easy and efficient installation of such a system is therefore desirable.

### BRIEF DESCRIPTION OF THE FIGURES

FIG. 1 illustrates an example topology of a system consistent with an embodiment of the present invention.

FIG. 2 illustrates the configuration of an RJ-11 connector, as may be used with various embodiments of the present invention.

FIG. 3 illustrates a flowchart of a method of practicing an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in various embodiments a system and method for automatically connecting a device to a telephone line on which telephone network signals are not present. Circuitry detects a telephone network signal on one or more of a plurality of telephone lines, and connects a device to a line on which a network signal was not detected. Such a system enables easy installation and configuration of a telephony system such as a Voice over DSL (VoDSL) or other such system that provides analog telephone service from within a building.

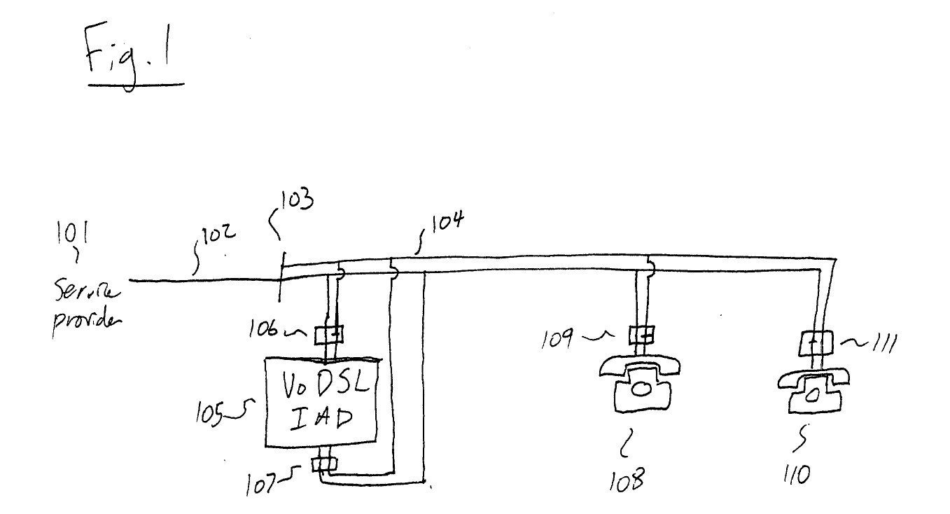

FIG. 1 illustrates an example topology of a system consistent with an embodiment of the present invention. A service provider 101 provides a copper wire pair connection 102 to the subscriber, which carries both POTS analog telephone and DSL digital data services. The telephone line connection 102 enters the customer premises at 103, and is routed via a cable that contains a second pair of wires for a second telephone line connection 104.

A Voice over DSL (VoDSL) Integrated Access Device (IAD) 105 is connected to the telephone line connections 102 and 104 via an RJ11 connection 106, and in some embodiments is further connected to the telephone lines 102 and 104 via a second RJ11 connection 107. Telephone 108 is connected to telephone line connections 102 and 104 via RJ11 connection 109, and telephone 110 is similarly connected to telephone line connections 102 and 104 via RJ11 connection 111.

In operation, the VoDSL LAD 105 is first installed in a manner that comprises connecting the IAD to the incoming copper wire pair 102 over which the service provider 101 provides the DSL signal. The IAD is also connected to copper wire pair 104, via RJ11 connection 106 or 107.

The VoDSL IAD detects which of the connected telephone lines 102 and 104 have a PSTN signal present, and after detecting that line 102 has a signal present from service provider 102 establishes an analog telephone service signal on 104. Detecting the PSTN signal in various embodiments comprises detecting a voltage between the pair of copper wires that form each telephone line, or detecting another signal associated with an active telephone service line.

Telephone 108 is plugged in to RJ11 connection 109, and telephone 18 is configured to connect to the first telephone line 102. Telephone 110 is plugged into RJ11 connection 111, and the telephone 110 is configured to connect to line 104. Because telephone 108 is connected to the telephone line 102, its telephone service is provided by the service provider 101. Telephone 110 is connected to telephone line 104, which is not connected to the service provider 101 but is connected to the VoDSL LAD 105. Telephone service for telephone 110 is therefore not provided by service provider 108 directly, but is provided via VoDSL IAD 105 which provides analog telephone service by transmitting and receiving voice data as digital data over its DSL connection.

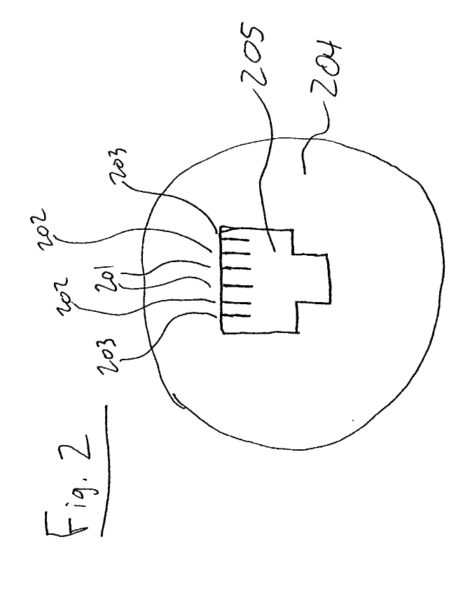

FIG. 2 illustrates the configuration of a typical RJ-11 connector, as may be used with various embodiments of the present invention. The telephone line designated as line one comprises a pair of wires connected to connections 201, line two comprises a pair of wires connected to connectors 202, and line three comprises a pair of wires connected to connectors 203. In this particular embodiment, a faceplate 204 has a recess or socket 205 which houses the connectors 201-203. The recess or socket 205 receives a matching plug that mates with connectors 201-203, and provides connection to telephone equipment.

A telephone or other device such as the VoDSL IAD 105 of FIG. 1 can connect to one, two, or three telephone lines via the line connection pairs 201-203 of FIG. 2, all through a single RJ11 connector. Telephones that operate on a single line may be configured or rewired to connect to any of these three lines, or multiple line telephones may be used to provide access to lines other than line one. In this manner, either of phones 108 or 110 may be configured or selected to operate with either telephone line 102 or 104.

The configurations shown here illustrate how configuration of a phone system, either operating alone or in conjunction with one or more other lines of telephone service, can uses an unused line of telephone service within a building to provide telephone service via a VoDSL IAD or other such device. Automatic detection of telephone service on connected lines enables automatic selection of a connected telephone line that is not already being used for providing telephone service via the IAD device.

In further embodiments of the invention, the IAD device 105 is not a DSL modem or device but is instead a cable modem connected to a network via a television cable or is another telephony device. In still further embodiments, device 105 is not a voice-over-data modem or other telephony service device, but is any other type of device which can make use of unused telephone lines of service within a building or house. Examples include home automation systems, alarm systems, thermostat or other HVAC control systems, networking systems, and other such systems.

The device will in some embodiments provide notification to a user of the resulting configuration, such as by use of indicator lights on the device that light to indicate which lines are already being used and to which line the device has automatically connected. In other embodiments, such notification may be provided via a network connection to an attached computer, via a device control panel display such as a LCD panel, or via any other such suitable display mechanism.

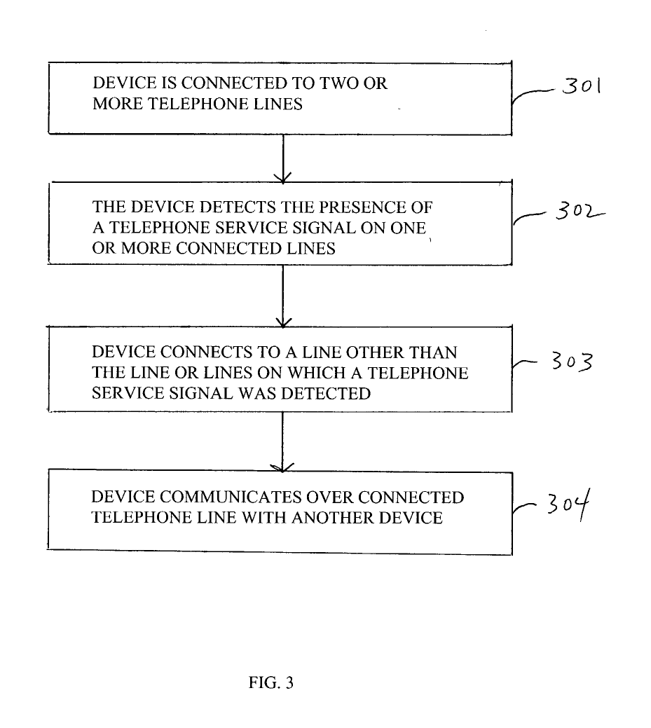

FIG. 3 illustrates a flowchart of a method of practicing an embodiment of the present invention. At 301, a device is connected to two or more telephone lines. The device in some embodiments of the invention comprises a telephone service device, such as a Voice over DSL or Voice over IP device, a DSL or cable modem, or other such device. At 302, the device automatically detects the presence of a telephone network signal on one or more of the connected telephone lines. The network signal is in various embodiments of the invention a voltage indicating live telephone service or any other signal suitable to identify an active telephone line. At 303, the device automatically couples itself to a telephone line other than the one or more connected lines on which a telephone network signal was detected. At 304, the device connects with one or more other devices over the connected telephone line. In some embodiments of the invention, the one or more other devices comprise telephones, to which the first device provides telephone service.

Although specific embodiments of systems and methods incorporating detection of a telephone network signal on a line and connecting a device to an unused line have been discussed in detail herein, they are only examples of the invention that illustrate such systems may be employed consistent with the appended claims. Other embodiments of the invention will utilize various combinations and configurations of the elements of the claims, all of which are within the scope of the present invention.

Specific embodiments have been illustrated and described herein, but it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A telephony service device, comprising:
a digital interface;
an analog telephone line interface;
circuitry operable to provide telephone service over the analog telephone line interface via a network connection to the digital interface;
a telephone network signal detector operable to detect a telephone network signal on one or more telephone lines connected to the analog telephone interface; and
a switch operable to automatically connect the telephony service device to a line on the analog telephone interface on which the telephone network signal detector did not detect a telephone network signal.

2. The telephony service device of claim 1, wherein the telephony access device comprises a DSL modem.

3. The telephony service device of claim 1, wherein the telephony device comprises a cable modem.

4. The telephony service device of claim 1, wherein the analog telephone interface comprises an RJ-11 connection.

5. The telephony service device of claim 1, wherein the telephony access device is a Voice Over DSL (VoDSL) device.

6. The telephony service device of claim 1, wherein the telephony access device is a Voice over IP (VoIP) device).

7. A method of automatically configuring a device having a connection to two or more telephone lines, comprising:
detecting within the device a telephone network signal on one or more connected lines; and
automatically connecting the device to a telephone line other than the one or more connected lines on which a telephone network signal was detected.

8. The method of claim 7, the method further comprising:
providing telephone service to the line to which the device is automatically connected via a digital connection to the device.

9. The method of claim 7, wherein the device comprises a Digital Subscriber Line (DSL) modem.

10. The method of claim 7, wherein the device comprises a cable modem.

11. The method of claim 7, wherein the connection to two or more telephone lines comprises an RJ-11 connection.

12. A computerized information handling system, comprising:
an analog telephone line interface;
a telephone network signal detector operable to detect a telephone network signal on one or more telephone lines connected to the analog telephone interface; and
a switch operable to automatically connect the computerized information handling system to a line via the analog telephone line interface on which the telephone network signal detector did not detect a telephone network signal.

13. The computerized information handling system of claim 12, further comprising circuitry operable to provide telephone service over the line to which the switch connects the computerized information handling system.

14. The computerized information handling system of claim 12, further comprising an Internet connection operable to carry voice data.

15. The computerized information handling system of claim 12, further comprising an IP connection operable to carry Voice over IP (VoIP) data.

16. The computerized information handling system of claim 12, wherein the analog telephone interface comprises an RJ-11 connection.
